(19) United States
(12) Patent Application Publication
(10) Pub. No.: US 2004/0017627 A1
(43) Pub. Date: Jan. 29, 2004

(54) Method for replicating ad protecting a surface relief

(76) Inventor: Jesper Tidemann, Losning (DK)

Correspondence Address: HARNESS, DICKEY & PIERCE, P.L.C., P.O. BOX 8910, RESTON, VA, 20195, US

(21) Appl. No.: 10/311,593

(22) PCT Filed: Jun. 28, 2001
(86) PCT No.: PCT/DK01/00452

(51) Int. Cl. G02B 5/08; G02B 7/182

(52) U.S. Cl. 359/883

(57) ABSTRACT

A method of manufacturing at least a part of a metal container where a relief, e.g. a hologram with a diffracting optical element, is being replicated in the surface of a soft layer of a metallic substrate and subsequently the surface relief is covered with a transparent layer. The transparent layer stabilises the soft layer of the metallic substrate and thereby protects the relief. The metallic substrate is subsequently formed into a metal container.

The present invention relates to a method for replicating a surface relief in a metallic substrate. In particular, the present invention relates to a method for replicating a surface relief in a soft metal layer and protecting at least part of the replicated surface relief with a substantially transparent layer. Furthermore, the present invention relates to a metal container for holding such a surface relief, said surface relief being protected according to the above-mentioned method.

The use of holograms for protecting printed materials and other products against counterfeiting has gained wide acceptance in industry today. Holograms are also used as decoration on printed materials, in particular packaging. Holograms are either applied as labels or by hot embossing of holographic foils. Generally, inducing holograms directly into metals is very costly whereby the cost of each item becomes relatively high.

U.S. Pat. No. 4,725,111 and U.S. Pat. No. 4,773,718 both pertain to processes of embossing holograms directly into a metal surface, preferably aluminium. Embossing holograms directly into metals require that high pressure be applied to the embossing tool in order to overcome the hardness of the metal. In U.S. Pat. No. 4,725,111 and U.S. Pat. No. 4,773,718 this problem has been solved by running the embossing process at elevated temperatures—i.e. the temperature of the metal is heated above room-temperature during embossing of holograms.

It is a disadvantage of the processes described in U.S. Pat. No. 4,725,111 and U.S. Pat. No. 4,773,718, that in order to soften the aluminium the embossing process must take place at elevated temperatures so as to reduce the hardness of the aluminium.

U.S. Pat. No. 4,900,111 describes a technique for embossing holograms into two-layer compositions—a hard metal substrate coated with a soft metal layer. By introducing this soft metal layer embossing may take place at room temperature. Preferably, the soft metal layer is a thin tin layer.

It is a disadvantage of the technique described in U.S. Pat. No. 4,900,111 that corrosion may easily damage the holograms. Corrosion will appear if the embossing tool penetrates the thin tin layer whereby the underlying substrate becomes freely exposed to the surroundings. Corrosion will not only damage the hologram—the complete structure/article upon which the hologram is positioned (e.g. a food container) will be destroyed. In case of a food container, the contents of the food container could be poisoned.

It is further a disadvantage of the technique disclosed in U.S. Pat. No. 4,900,111 that the induced holograms are not at all protected and are thus freely exposed to the surroundings—i.e. air, humidity and other, for the holograms, dangerous objects. In the present content a dangerous object could be the hands or nails of a customer touching the holograms during handling of an article upon which the holograms have been introduced.

It is a still further disadvantage of the technique disclosed in U.S. Pat. No. 4,900,111 that due to the softness of the soft metal layer, the holograms will be easily destroyed since physical contact between the soft metal layer and other objects—other than the embossing tool—will probably change the surface properties of the holograms.

It is a still further disadvantage of the technique described in U.S. Pat. No. 4,900,111 that the intended visual effects will be influenced or destroyed by dust particles sticking to the surface of the holograms.

It is an object of the present invention to provide a technique for replicating a surface relief in a metal substrate without applying high pressure to the embossing tool.

It is a further object of the present invention to mechanically stabilise the surface of the replicated surface relief by providing a transparent layer on top of the surface relief so as to protect the replicated surface relief against the surroundings and thereby maintain the intended visual effects of the surface relief.

It is a further object of the present invention to provide a technique for replicating a surface relief in a metal substrate at high speeds and at room temperature. In particular, the technique should be applicable to high-speed production lines for manufacturing of e.g. metal containers.

It is an object of the present invention to provide an effective protection against corrosion so as to avoid damaging/destroying of the replicated surface relief and the article holding the replicated surface relief.

The above-mentioned objects are complied with by providing, in a first aspect, a method of manufacturing at least part of a metal container, said method comprising the steps of:

providing a metallic substrate, said metallic substrate being substantially plane and having two substantially parallel surfaces,

replicating a surface relief, said surface relief being held by a surface of an object, by pressing the object into one of the surfaces of the substrate in order to change surface properties of at least part of that surface, and

covering at least part of the replicated surface relief with a substantially transparent layer so as to protect the replicated surface relief.

The method according to the first aspect of the present invention may further comprise the step of forming at least part of the metallic substrate into at least part of a metal container after at least part of the replicated surface relief has been covered with the substantially transparent layer.

In a second aspect, the present invention relates to a method of manufacturing at least part of a metal container, said method comprising the steps of:

providing a metallic substrate, said metallic substrate being substantially plane and having two substantially parallel surfaces,

replicating a surface relief, said surface relief being held by a surface of an object, by pressing the object into one of the surfaces of the substrate in order to change surface properties of at least part of that surface,

forming at least part of the metallic substrate into at least part of a metal container, and

covering at least part of the replicated surface relief with a substantially transparent layer so as to protect the replicated surface relief.

In principle, the metal substrate may be processed to form any part of the metal container—i.e. top portion, bottom portion or sidewall portion of the metal container.

Generally speaking, the step of forming at least part of the metallic substrate into at least part of the metal container may involve two-piece or three-piece technologies. Two-piece technologies may involve deep drawing, stamping, draw redraw and/or drawn and wall-ironed processes. In case of three-piece technologies welding, gluing, soldering and folding may be applied in addition to the above-mentioned two-piece processes.

The metallic substrate may hold a first layer, the first layer being softer than the substrate. The first layer may comprise a material selected from the group consisting of tin, aluminium, copper, nickel, zinc, brass or any combination thereof. The surface relief which may be a diffracting optical element—may be replicated in the first layer. The replication of the surface relief may be performed as a part of a rolling process or a stamping process.

The substantially transparent layer may be selected from the group consisting of lacquers, polymers, laminated plastic, printing inks or any combination thereof. The substantially transparent layer may be a colour print so as to further enhance visual effects of the surface relief. The colour print may comprise decorations, such as logos, trademarks etc.

The substantially transparency of the colour print allowing light to shine through and thus affect the diffractive optical element of the relief.

In a third aspect, the present invention relates to a metal container comprising:

a body having a bottom and a side-wall portion, the bottom and side-wall portion forming in combination an inner and an outer surface, and

a surface relief being held by a surface part of the inner or outer surface of the body, said surface relief being at least partly covered with a substantially transparent layer so as to protect the surface relief.

The metal container may further comprise a top portion, said top portion forming an inner and an outer surface in combination with the bottom and sidewall portion when positioned on the body of the metal container.

The surface part holding the surface relief may comprise an inner and an outer layer, the outer layer being softer than the inner layer. The outer layer may comprise a material selected from the group consisting of tin, aluminium, copper, nickel, zinc, brass or any combination thereof.

The surface relief may comprise a diffracting optical element and may be held by the outer layer.

The substantially transparent layer covering at least part of the surface relief may be selected from the group consisting of lacquers, polymers, laminated plastic, printing inks or any combination thereof.

The metal container may be a two-piece or three-piece container. In principle, the metal container may take any form and size, and may be used for storing basically anything, such as food, beverage, paint, tobacco and shoe polish.

In a fourth aspect, the present invention relates to a method of manufacturing at least part of a metal container, said method comprising the steps of:

providing a metallic substrate, said metallic substrate being substantially plane and having two substantially parallel surfaces, wherein at least one of the surfaces of said metallic substrate holds a first layer of material, said first layer of material being softer than the metallic substrate, and wherein the first layer of material holds a second layer of non-transparent material,

replicating a surface relief, said surface relief being held by a surface of an object, by pressing the object into the first and second layers, and

covering at least part of the replicated surface relief with a substantially transparent layer so as to protect the replicated surface relief.

The method according to the fourth aspect may further comprise the step of forming at least part of the metallic substrate into at least part of a metal container.

In a fifth aspect, the present invention relates to a method of manufacturing at least part of a metal container, said method comprising the steps of:

providing a metallic substrate, said metallic substrate being substantially plane and having two substantially parallel surfaces, wherein at least one of the surfaces of said metallic substrate holds a first layer of material, said first layer of material being softer than the metallic substrate, and wherein the first layer of material holds a second layer of non-transparent material,

replicating a surface relief, said surface relief being held by a surface of an object, by pressing the object into the first and second layers,

forming at least part of the metallic substrate into at least part of a metal container, and

covering at least part of the replicated surface relief with a substantially transparent layer so as to protect the replicated surface relief.

The second layer of non-transparent material according to the fourth and fifth aspects of the present invention may be a colour print so as to enhance visual effects. The colour print may comprise decorations, such as logos, trademarks etc.

The present invention will now be described in further details with reference to the accompanying figures, where

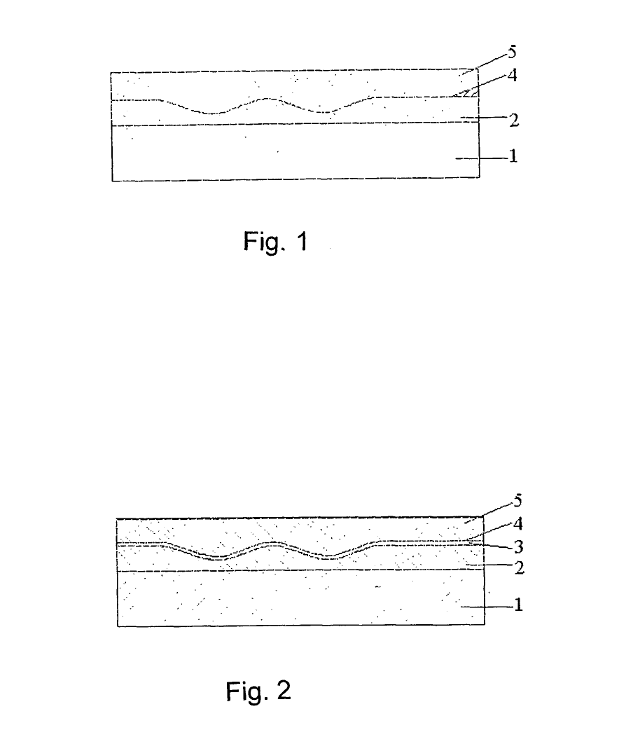

FIG. 1 illustrates a surface relief 4 replicated in a soft metallic layer 2. The soft metallic layer 2 is being held by a metallic substrate 1. The replicated surface relief is covered with a substantially transparent layer 5,

FIG. 2 shows a system similar to FIG. 1 now including a colour print 3,

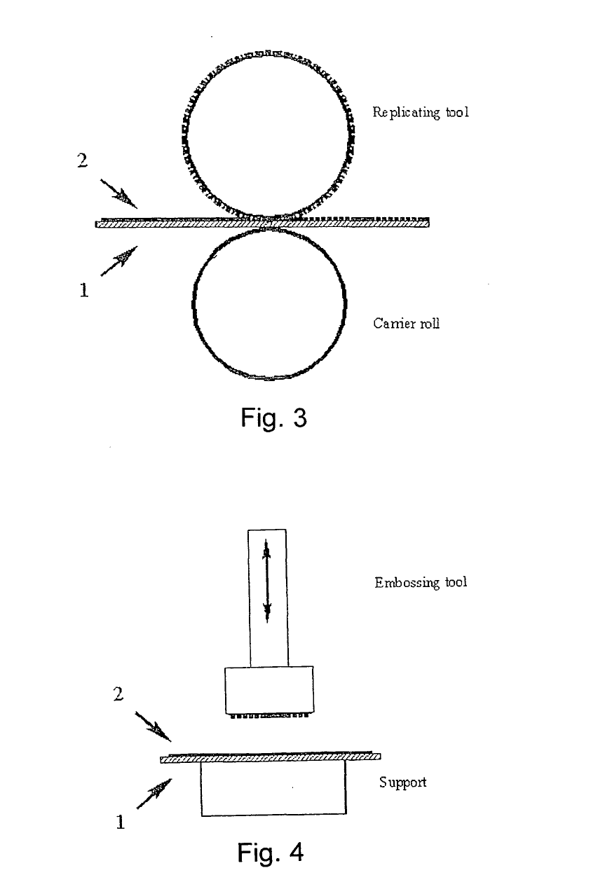

FIG. 3 shows the principle of a rolling process,

FIG. 4 shows the principle of a stamping process,

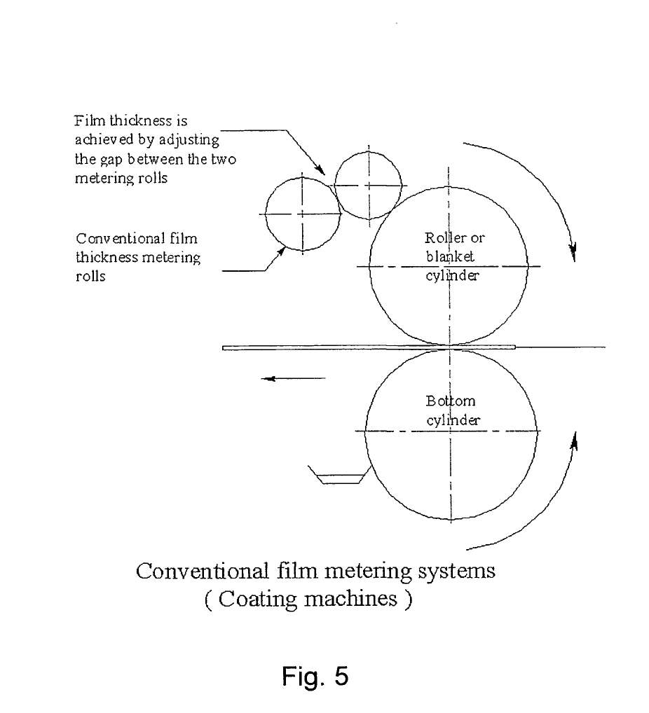

FIG. 5 illustrates the step of providing the protective transparent layer, and

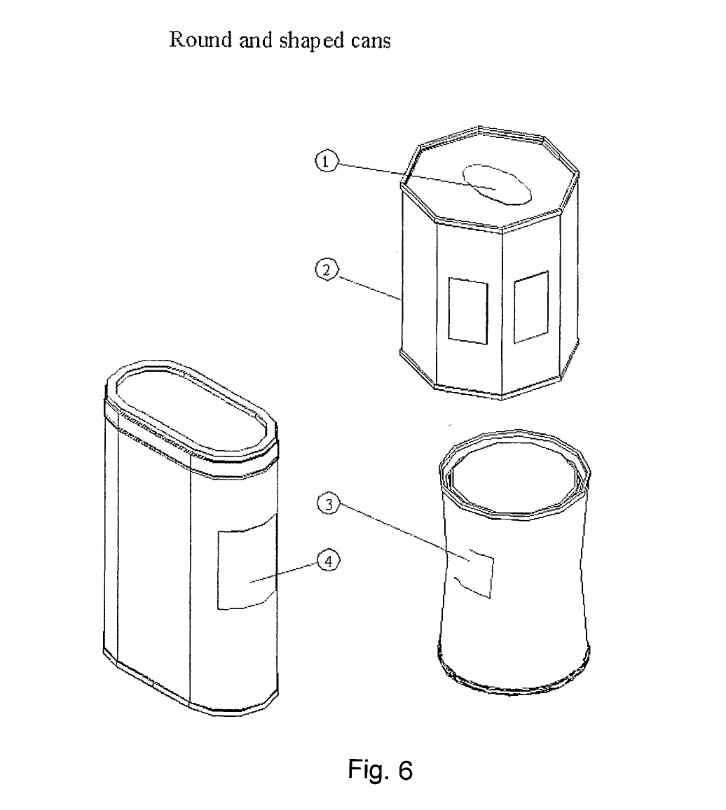

FIG. 6 shows a variety of cans all carrying integrated holograms 1-4.

The replicated surface reliefs—e.g. holograms—will, according to the present invention, form an integral part of the final product, i.e., an integral part of a metal container. By integrating the surface relief with the final product counterfeiting becomes very difficult. Furthermore, since the replication of e.g. holograms is an integral part of the overall production cuts and savings in production time and resources are achieved.

Referring now to FIG. 1, an article according to a preferred embodiment of the present invention is shown. The article comprises a plane metal substrate 1. The surface of the substrate should be as smooth as possible. Preferably, the substrate is metal, such as steel or aluminium. In the situation where the substrate is made of steel, the steel is coated with a layer 2 having an appropriate softness. Preferably, the layer 2 is a soft metallic material—e.g. a tin layer—whereby embossing of holograms may be performed at room temperature. The possibility of embossing holograms at room temperature is a requirement since the method according to the present invention is adapted to high-speed production facilities.

The system illustrated in FIG. 1 is shown as a two-layer system. In principle, the system may comprise several layers e.g. positioned symmetrically around the substrate. For example, the substrate may be covered with a tin layer on both sides. The tin layers may then be covered with a passivation layer. Alternatively, the system can be a one-layer system. A one-layer system could be a system where the substrate is made of aluminium. Since aluminium is soft by nature, no additional soft coating layer is required in order to emboss holograms at room temperature.

In FIG. 1, a surface relief 4 has been replicated in the tin layer 2. The replicated surface relief 4 is seen as small spatial variations in the surface topology of the tin layer 2. The surface relief may cover the complete substrate or it may only cover part of the substrate. Preferably, the surface relief 4 is a diffracting optical element, such as a hologram, grating or the like. The thickness of the tin layer should be sufficient to absorb the depth variations of the surface relief 4. These variations are typically in the 50-300 nm range.

If the replicated surface relief was left unprotected it would just be a question of time—presumably very short time—before the intended visual effect would disappear due to the fact that the induced spatial variations of the surface of the replicated surface would be smeared out due to e.g. dust particles sticking to the surface of the replicated surface relief and thus partly or fully filling out the spatial variations. Also wear due to e.g. touching of the surface relief would destroy or reduce the intended visual effects over time. Therefore, in a preferred embodiment, a transparent layer 5 protects the surface relief 4. One side of the protective layer 5 follows the spatial variations of the surface relief 4. Preferably, the protective layer 5 is a lacquer, polymer, laminated plastic, printing ink or a combination thereof. The protective layer 5 way in a similar way be provided on top of a one-layer system in order to protect a replicated surface relief in an aluminium substrate (not shown in FIG. 1).

Even more preferably, the protective layer 5 is one of the following lacquers—DI 4004 or lacquer no. 1402-011 both supplied by the company Valspar Coates. Alternatively, the following lacquers may be used:

EG 41001 F, EG 41082 F and EQ 16003 F from PPG

77/6/5 Z from Vernicolor

11545 from Manders

ME 812 F, 11 573MA from Valspar Coates

Visual effects may also be enhanced if the material system shown in FIG. 1 also comprises a colour print 3—as illustrated in FIG. 2. The colour print 3 is a colour layer positioned on top of the tin layer 2. The colour print 3 will typically contain a decoration, such as a logo, trademark etc. The best visual effects have been observed using dark colours, e.g. dark blue. The surface relief is replicated by pressing an embossing tool into both the colour print 3 and the tin layer 2 so as to change the surface properties of both layers. However, by use of partially transparent colours, the embossing tool may be pressed into the tin layer, the colour print to be applied succeedingly. Accordingly, the colour print may serve both for the decorative visual effect and for the protection of the replicated surface relief.

Rolling or stamping processes are suitable candidates for the replication of surface reliefs. The general principle of a rolling process is illustrated in FIG. 3 where the carrier roll is adapted to hold and move the substrate 1 holding the layer 2—e.g. a tin layer. The replicating tool, which also takes part in moving the substrate, is positioned above the carrier roll. The pressure applied to the replicating tool during embossing is dependent on the properties of the layer 2.

In FIG. 4, a stamping process is illustrated. The substrate 1 holding the layer 2 is positioned on a support structure. Again, the embossing tool is pressed into the layer 2 in order to replicate a surface relief.

For industrial purposes, where high-speed manufacturing is required, the rolling process is the most favourable. Furthermore, the rolling process may be easily adapted to conventional rolls. The number of item manufactured per hour may easily be as high as 100.000 depending on the item to be manufactured.

The protective layer 5 may be formed on top of the surface of the replicated surface relief using a film metering system—as shown in FIG. 5.

Preferably, the protective layer 5 is provided to the surface relief before the substrate—including the surface relief—is processed in order to form part of a metal container. The processed part can be sidewalls of the metal container. Alternatively, the substrate holding the replicated surface relief can be processed to form other parts of the metal container—e.g. top and/or bottom part of the metal container.

In another embodiment, the substrate including the surface relief is formed to form part of a metal container before the protective layer 5 is provided. Again, the substrate including the replicated surface relief can be processed to form any part of the metal container, i.e. sidewall (or only part thereof, top portion or bottom portion. The protective layer 5 is provided to the surface reliefs after the metal container has been formed.

It is an advantage of the present invention that the shape of the metal container may take any form. Some illustrative examples are shown in FIG. 6. Thus, the present invention apply to metal containers having e.g. circular, elliptical, rectangular, quadratic, polygon-shaped (more than four side-portions) cross-sectional areas.

It is another advantage of the present invention that the replicated surface relief can be positioned at any position on the metal container. This being due to the fact that the surface relief is replicated on a substantially plane surface which is processed afterwards in order to form part of the metal container. Furthermore, different types of surface reliefs may be positioned at different places on the metal container, e.g. on the bottom portion, on the sidewall or on a top portion or closure for the container, either on the inward facing surfaces or on the outward facing surfaces. Thus, the flexibility of the methods according to the present invention is huge.

The techniques applied to form the substrate into metal containers depend on the type of metal container to be fabricated. In case of a two-part metal container, deep drawing would be an appropriate technique for manufacturing the sidewall and bottom portion. The top portion is manufactured separately. In case of a three-part metal container, the bottom, sidewall and top portions are manufactured independently.

1. A method of manufacturing at least part of a metal container, said method comprising the steps of:
providing a metallic substrate, said metallic substrate being substantially plane and having two substantially parallel surfaces,
replicating a surface relief, said surface relief being held by a surface of an object, by pressing the object into one of the surfaces of the substrate in order to change surface properties of at least a part of that surface,
providing a colour layer on the surface relief, and
covering the colour layer with a substantially transparent protecting layer.

2. A method according to claim 1, further comprising the step of forming at least part of the metallic substrate into at least part of a metal container.

3. A method according to claim 1 or 2, wherein the provided metallic substrate holds a first layer, the first layer being softer than the substrate.

4. A method according to claim 3, wherein the first layer comprises a material selected from the group consisting of tin, aluminium, copper, nickel, zinc, brass or any combination thereof.

5. A method according to claim 3 or 4, wherein the surface relief is replicated in the first layer.

6. A method according to any of the preceding claims, wherein the replicated surface relief comprises a diffracting optical element.

7. A method according to any of the preceding claims, wherein the substantially transparent layer is selected from the group consisting of lacquers, polymers, laminated plastic, printing inks or any combination thereof.

8. A method according to any of the preceding claims, wherein the substantially transparent layer comprises a substantially transparent colour print.

9. A method according to any of the preceding claims, wherein the replication of the surface relief is performed as a part of a rolling process.

10. A method according to any of claims 1-8, wherein the replication of the surface relief is performed in a stamping process.

11. A method according to any of claims 2-10, wherein the step of forming at least part of the metallic substrate into at least part of a metal container using two-piece or three-piece technologies.

12. A metal container comprising:
a body having a bottom and a side-wall portion, the bottom and side-wall portion forming in combination an Inner and an outer surface,
a surface relief being held by a surface part of the inner or outer surface of the body,
a colour layer covering the surface relief, and
a substantially transparent protecting layer covering the colour layer.

13. A metal container according to claim 12, further comprising a top portion, said top portion forming an inner and an outer surface in combination with the bottom and sidewall portion when positioned on the body of the metal container.

14. A metal container according to claim 12 or 13, wherein the surface part holding the surface relief comprises an inner and an outer layer, the outer layer being softer than the inner layer.

15. A metal container according to claim 14, wherein the outer layer comprises a material selected from the group consisting of tin, aluminium, copper, nickel, zinc, brass or any combination thereof.

16. A metal container according to any of claims 12-15, wherein the surface relief comprises a diffracting optical element.

17. A metal container according to any of claims 14-16, wherein the surface relief is being held by the outer layer.

18. A metal container according to any of claims 12-17, wherein the substantially transparent layer covering at least part of the surface relief is selected from the group consisting of lacquers, polymers, laminated plastic, printing inks or any combination thereof.

19. A metal container according to any of claims 12-18, wherein the substantially transparent layer comprises a substantially transparent colour print.

20. A metal container according to any of claims 12-19, wherein the metal container is a two-piece container.

21. A metal container according to any of claims 12-19, wherein the metal container is a three-piece container.

22. A metal container according to any of claims 12-21, wherein the metal container is a metal container for storing food, beverage, paint, tobacco and shoe polish.
